(19) United States
(12) Patent Application Publication
(10) Pub. No.: US 2009/0158917 A1
(43) Pub. Date: Jun. 25, 2009

(54) MOBILE ELECTRONIC DEVICE HAVING ONE TOUCH MUSIC PLAY

(75) Inventor: James Filicette, Libertyville, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/960,202

(22) Filed: Dec. 19, 2007

(51) Int. Cl. G10H 1/00

(52) U.S. Cl. 84/601

(57) ABSTRACT

A mobile electronic device includes a user interface displaying a music play icon, and a memory storing music. Selection of the music play icon by a user causes the mobile electronic device to play music stored in the memory without further interaction by the user with the mobile electronic device.

### BACKGROUND OF THE INVENTION

1. Field of the Invention

The invention relates to an electronic device, and in particular, to an electronic device having a one touch music play capability.

2. Introduction

Electronic devices, such as cellular phones, handheld computers, MP3 players, and the like are very pervasive computing devices. The electronic devices provide various features, such as communications, computing features, Internet access, playing music or video, viewing images, etc. Such electronic devices will often include a display, such as an LCD (liquid crystal display).

New applications are being developed for such mobile computing electronic devices. Some mobile computing devices may include features that allow a user to play music, for example. However, these mobile computing devices do not allow the user to easily begin playing music, often requiring a user to navigate through several keystrokes and menus to begin playing music.

For example, a typical mobile phone or other device may require a user to press a music or other key to open an application, to navigate through one or more menus to find the desired music, and to select the music to play. Where the user wants to play a playlist in random or shuffle modes, to play a playlist, or to play music of a particular type, for example, it may be even more complicated, such as requiring the user to press a music key to open an application, select options, turn on a shuffle or other mode (random, etc.), exit the options menu, go to a list to play and select it, select options, and play all. This is very complicated for a user who simply wants to start playing music.

### SUMMARY OF THE INVENTION

A mobile electronic device includes a user interface displaying a music play icon, and a memory storing music. Selection of the music play icon by a user causes the mobile electronic device to play music stored in the memory without further interaction by the user with the mobile electronic device.

### BRIEF DESCRIPTION OF THE DRAWINGS

In order to describe the manner in which advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of an mobile electronic device in accordance with embodiments of the invention;

FIG. 2 illustrates a block diagram of an exemplary electronic device in accordance with embodiments of the invention;

FIG. 3 illustrates a diagram of an exemplary mobile electronic device in accordance with embodiments of the invention;

FIG. 4 is an diagram of an exemplary mobile electronic device in accordance with embodiments of the invention; and

FIG. 5 is a flow chart of an exemplary method in accordance with embodiments of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without departing from the spirit and scope of the invention.

The invention comprises a variety of embodiments, such as a method and apparatus and other embodiments that relate to the basic concepts of the invention.

In a typical electronic device, an LCD display or other type of display is often used to display user interface information and visual content such as video, images, text, etc., and a user interface such as a keypad, touchpad, etc. may be provided allowing the user to interface with the device. For example, cellular phones, handheld computers and other mobile computing devices often come equipped with such a display and user interface. These computing devices may store music and be equipped with the ability to play the music upon appropriate input from the user. However, the input required from the user to begin playing music is often somewhat complex and confusing.

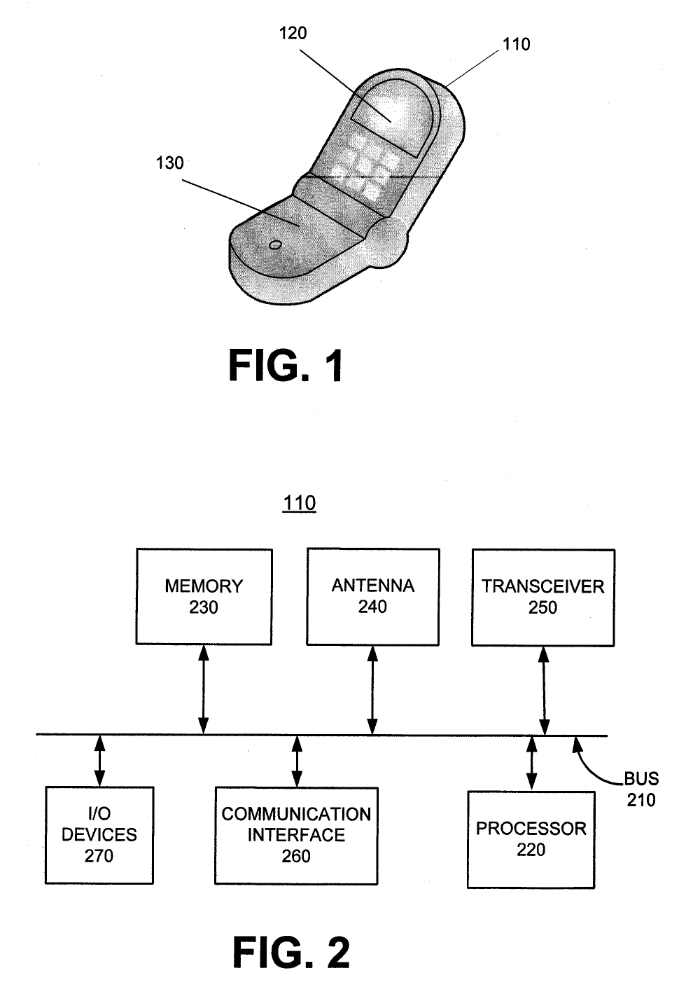

FIG. 1 illustrates an exemplary diagram of an electronic device 110 in accordance with a possible embodiment of the invention. The electronic device 110 may be any mobile or portable computing device, including a mobile telephone, cellular telephone, a wireless radio, a portable computer, a laptop, an MP3 player, satellite radio, satellite television, etc. The electronic device 110 may have a display 120, which may be a display such as an LCD display or touchpad, for example. The electronic device 110 may also include a keypad 130 or other elements allowing user input, although if a touchpad is used, a keypad may not be needed. The electronic device 110 may include additional elements not shown herein.

FIG. 2 illustrates a block diagram of an exemplary electronic device 110 in accordance with a possible embodiment of the invention. The exemplary mobile electronic 110 may include a communication bus 210, a processor 220, and a memory 230. The bus 210 may permit communication among the components of the electronic device 110. The electronic device 110 may include other optional elements such as an antenna 240, a transceiver 250, a communication interface 260, and input/output I/O) devices 270, although all of these elements may not be necessary to practice the invention.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM which may include a conventional ROM device or another type of static storage device that stores static information and instructions for processor 220.

Transceiver 240 may include one or more transmitters and receivers. The transceiver 240 may include sufficient functionality to interface with any network or communication station and may be defined by hardware or software in any manner known to one of skill in the art. The processor 220 is cooperatively operable with the transceiver 240 to support operations within the network.

Input/output devices I/O devices) may include one or more conventional input mechanisms that permit a user to input information to the mobile communication device 110, such as a microphone, touchpad, keypad, keyboard, mouse, pen, stylus, voice recognition device, buttons, etc. Output devices 270 may include one or more conventional mechanisms that output information to the user, including a display, one or more speakers, a storage medium, such as a memory, magnetic or optical disk, disk drive, and printer, etc., and/or interfaces for the above. The display may typically be an LCD display or touchpad, as used on many conventional mobile computing devices.

The electronic device 110 may perform functions in response to processor 220 by executing sequences of instructions or instruction sets contained in a computer-readable medium, such as, for example, memory 230. Such instructions may be read into memory 230 from another computer-readable medium, such as a storage device or from a separate device via a communication interface.

The electronic device 110 illustrated in FIGS. 1-2 and the related discussion are intended to provide a brief, general description of a suitable electronic device and processing environment in which the invention may be implemented. Although not required, the invention will be described, at least in part, in the general context of computer-executable instructions, such as program modules, being executed by the electronic device 110, such as a mobile telephone, or a television set-top box. Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including cellular devices, mobile communication devices, personal computers, hand-held devices, multi-processor systems, microprocessor-based or programmable consumer electronics, and the like.

Music may be stored in the memory 230 for later playback in standard and well know ways, such as downloading from the Internet either to a computer and then transferred to the memory 230 or downloaded directly to the mobile electronic device where there is an available Internet connection. Any method of transferring music to memory 230 will work with embodiments of the invention.

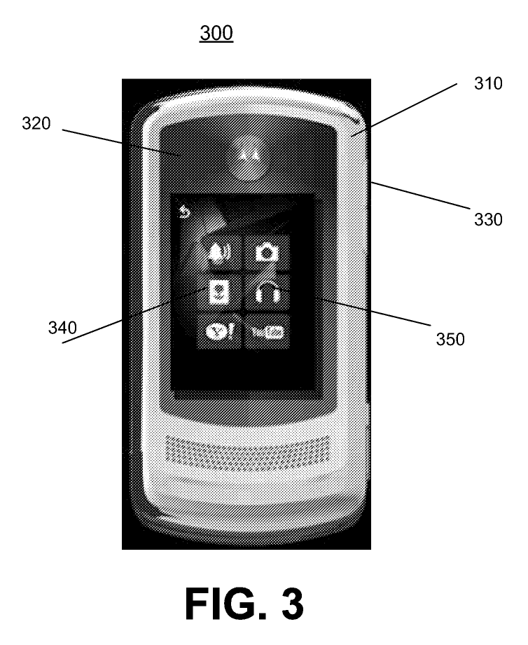

FIG. 3 illustrates an exemplary diagram of an electronic device 300 in accordance with a possible embodiment of the invention. The electronic device 300 may be one of various types of computing devices, such as a mobile or cellular phone, a personal data assistant, an mp3 player, and so forth. The electronic device 300 may include an outer case 310 and a screen 320. The screen 320 may be an LCD screen, for example, and may be a touchpad type screen capable of displaying information to a user an allowing user input by, for example, the user touching the screen or placing a finger near the screen as well known in the art of such electronic devices. The electronic device 300 may include buttons 330 allowing various functionality, such as power, volume and so forth.

Additionally, the screen 320 may be enabled to display various icons 340. The icons may visually convey to the user a functionality that may be implemented by the user activating the icon, such as a phone icon, a camera icon, an Internet icon, and so forth. The icons 340 may include a music icon 350. As further explained below, activation of the music icon 350 may allow the user to immediately begin playing music. The icons may be activated by touch or other means such as voice activation, through the use of a keyboard, and so forth. The music icon 350 may also be implemented as a music button on the electronic device 300.

The electronic device 300 may be a mobile phone as described above, and may be a standard phone with a screen visible from the outside, or may be a clamshell type or flip mobile phone that opens. A flip phone is generally hinged at the bottom, while a clamshell phone is hinged at the top. In a closed position, the clamshell or flip phone may have a screen visible from the outside, and may have another screen visible when opening the clamshell or flip phone, or may have only the screen visible when opening the clamshell mobile phone.

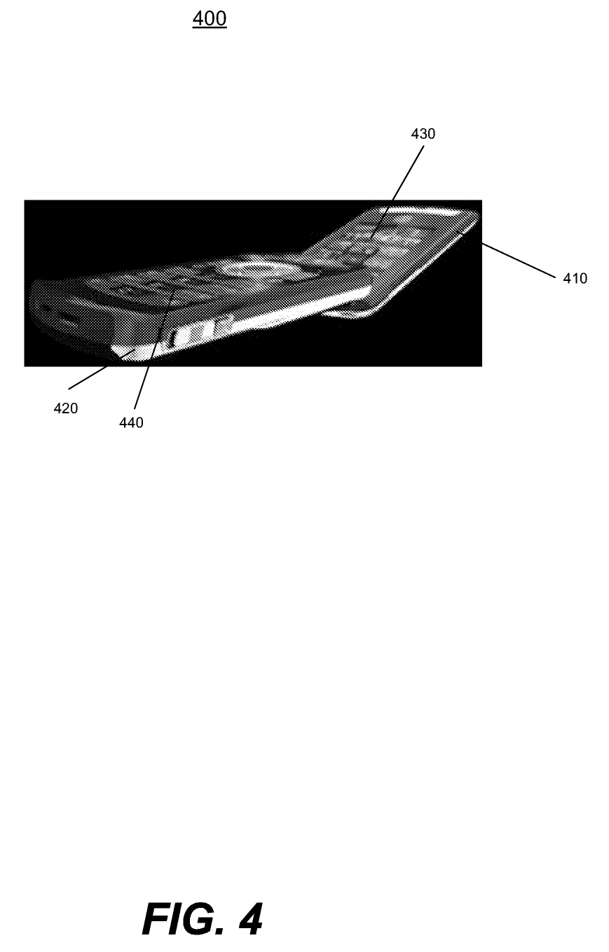

The electronic device 400 in FIG. 4 may be a clamshell type mobile phone with a hinge as shown, which has an upper case 410 connected by the hinge to the lower case 420. The upper case 410 may include a user interface 430, which may have a screen such as an LCD or touchpad allowing the user to interface with the electronic device. The lower case 420 may have a user interface 440 such as a keyboard, keypad, touchpad and so forth, that may be used to input items such as phone numbers and so forth. The icons 340 shown in FIG. 3 could be displayed to the user on either or both of the user interfaces 430, 440. In a preferred embodiment, the electronic device 400 may included two user interfaces capable of displaying the icons 340 on the upper case 410, one that is visible to the user when the electronic device is closed, such as depicted in FIG. 3 (when the embodiment of FIG. 3 is a clamshell type phone), and another one on the opposite side of the upper case 410 as 430. This allows the user to see the icons 340 when the electronic device is in either an open position as in FIG. 4 or a closed position.

Embodiments of the present invention provide the electronic device with the ability to play music with one input or touch to one of the user interfaces. In preferred embodiments, the user merely has to touch or otherwise activate the music icon 350, and the electronic device will immediately begin playing music. This avoids the user from having to go through a series of screens or menus to begin playing music. The music may be listened to by the user in ways well known such as through an external speaker on the electronic device or on a headset connected to the electronic device.

Where the user has stored more than one song in the memory of the electronic device, the music may be played to the user with all the songs played one after another. Additionally, the user may preselect a default way of playing the music stored in the electronic device. The user may have music stored in playlists, by artist, by type of music and so forth as is well known in various music playing devices. The user may select a default music play that will be implemented when the user selects the music icon 350. For example, the user may preselect to play music of a particular artist, to play music of a series of artists in a preselected order, to play music randomly, to play a particular playlist, to play a series of playlists in a particular order, to play a particular type of music such as country, to play any of the preceding in a random or shuffle mode, and so forth. Typically, the user will preselect the default music play that is to be implemented with menus presented to the user on the user interfaces, such as user interface 430. Any other way of selecting the default music play method to be implemented would work equally well with embodiments of the invention, such as verbal commands from the user received by the electronic device 300, 400.

Once the user has selected a default music play method, any time the user selects or activates the music icon 350, the electronic device will instantly begin playing music according to the selected default music play method. This avoids the user having to go through a series of menus and screens, opening applications such as a music player application, selecting the music to be played and so forth, every time the user wants to play music.

Additionally, embodiments of the invention may include a default music play method selected by the manufacturer, a distributor, or a seller of the electronic device. For example, when purchased by a user, the electronic device 300, 400 may be programmed to play all music randomly, although any of the default music play methods could be used. In these embodiments, the user may be given the option to select another default music play method, such as selecting from those described above, which may override any default music play method preselected by the manufacturer, distributor, or seller of the electronic device 300, 400.

Embodiments of the invention may be implemented on any portable electronic device capable of playing music. These devices may be programmed to play music with a simple activation of the music icon as described above. Additionally, embodiments of the invention may work equally well with any type of indication to play music that is selectable by a user, other than the above-described music icon, such as a button, voice activation, and so forth. The mobile electronic device may be one of a mobile telephone, a cellular telephone, a wireless radio, a portable computer, an MP3 player, a remote control device, and a satellite radio, for example.

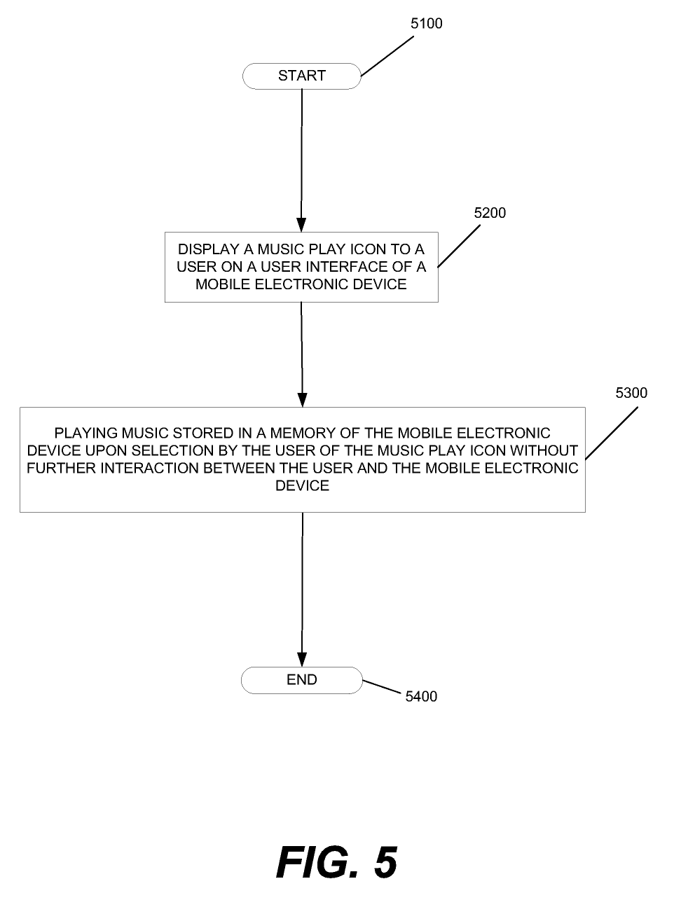

FIG. 5 illustrates a flowchart of a method of providing music to a user of a portable electronic device in accordance with embodiments of the invention. In step 5100, the method starts.

In step 5200, a music play icon is displayed to a user on an interface of the mobile computing device. In step 5300, music stored in a memory of the mobile electronic device is played upon selection by the user of the music play icon without further interaction between the user and the mobile electronic device. In step 5400, the process ends.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. A mobile electronic device, comprising:
a user interface displaying a music play icon; and
a memory storing music;
wherein selection of the music play icon by a user causes the mobile electronic device to play music stored in the memory without further interaction by the user with the mobile electronic device.

2. The mobile electronic device of claim 1, wherein selection of the music play icon causes the music to be play in a predetermined order.

3. The mobile electronic device of claim 2, wherein the predetermined order is selected by a manufacturer, distributor or seller of the mobile electronic device.

4. The mobile electronic device of claim 2, wherein the predetermined order is preselected by the user of the mobile electronic device.

5. The mobile electronic device of claim 3, wherein the predetermined order selected by the manufacturer, distributor or seller of the mobile electronic device may be overridden by the user of the mobile electronic device.

6. The mobile electronic device of claim 2, wherein the predetermined order is one of a random order, a by artist order, a by type of music order, a by playlist order, or a by ratings order.

7. The mobile electronic device of claim 1, wherein the mobile electronic device is a mobile phone of a flip type or a clamshell type, and the music play icon is on an interface visible to the user when the mobile electronic device is in a closed position.

8. The mobile electronic device of claim 1, wherein the mobile electronic device is one of a mobile telephone, a cellular telephone, a wireless radio, a portable computer, an MP3 player, a remote control device, and a satellite radio.

9. A method of providing music to a user of a mobile electronic device, comprising:
displaying a music play icon to a user on a user interface of the mobile electronic device; and
upon selection of the music play icon by the user, playing music stored in a memory of the mobile computing device without further interaction with the user.

10. The method of claim 9, further comprising playing the music in a predetermined order.

11. The method of claim 10, wherein the predetermined order is selected by a manufacturer, distributor or seller of the mobile electronic device.

12. The method of claim 10, wherein the predetermined order is preselected by the user of the mobile electronic device.

13. The method of claim 11, wherein the predetermined order selected by the manufacturer, distributor or seller of the mobile electronic device may be overridden by the user of the mobile electronic device.

14. The method of claim 10, wherein the predetermined order is one of a random order, a by artist order, a by type of music order, a by playlist order, or a by ratings order.

15. The method of claim 9, wherein the mobile electronic device is a mobile phone of a flip type or a clamshell type, and the music icon is on an interface visible to the user when the mobile electronic device is in a closed position.

16. The method of claim 9, wherein the mobile electronic device is one of a mobile telephone, a cellular telephone, a wireless radio, a portable computer, an MP3 player, a remote control device, and a satellite radio.

17. A mobile phone, comprising:
a user interface having a music play button selectable by a user;
a memory storing music;
wherein selection of the music play button by the user causes the mobile phone to play the music stored in the memory without further interaction by the user with the mobile phone.

18. The mobile phone of claim 17, wherein selection of the music play icon causes the music to be play in a predetermined order selectable by either 1) a manufacturer, distributor or seller of the mobile phone; or 2) the user of the mobile phone.

19. The mobile phone of claim 17, wherein the predetermined order is one of a random order, a by artist order, a by type of music order, a by playlist order, or a by ratings order.

20. The mobile phone of claim 17, wherein the mobile phone is of a flip type or a clamshell type, and the music play button is on an interface visible to the user when the mobile phone is in a closed position.
